(19) United States
(12) Patent Application Publication
(10) Pub. No.: US 2026/0147203 A1
(43) Pub. Date: May 28, 2026

(54) ARRANGEMENT METHOD OF NANO-PILLARS OF META-LENS

(71) Applicant: INDUSTRIAL TECHNOLOGY RESEARCH INSTITUTE, HSINCHU (TW)

(72) Inventors: Chang HUANG, New Taipei City (TW); Guan-Yu ZHU, Taoyuan City (TW); Hsing-Wei HUANG, Hsinchu City (TW); Ming-An CHEN, Taipei City (TW)

(21) Appl. No.: 19/001,394

(22) Filed: Dec. 24, 2024

(30) Foreign Application Priority Data
Nov. 25, 2024 (TW) 113145388

(51) Int. Cl. G02B 27/00; G02B 3/00

(52) U.S. Cl. CPC G02B 27/0012; G02B 3/0043

(57) ABSTRACT

An arrangement method of nano-pillars of a meta-lens provided by embodiments of the present disclosure includes dividing a first nano-pillar array into a sub-unit matrix including multiple sub-units, obtaining an out-of-specification locating matrix from the sub-unit matrix to locate an out-of-specification sub-unit in the first nano-pillar array, obtaining an average phase matrix from the sub-unit matrix, building a substitution sub-unit database by using the out-of-specification locating matrix and the average phase matrix, and selectively substituting the out-of-specification sub-unit in the first nano-pillar array by using the substitution sub-unit database to obtain a second nano-pillar array.

### CROSS-REFERENCE TO RELATED APPLICATION

The present application is based on, and claims priority from, Taiwan Application Serial Number 113145388, filed Nov. 25, 2024, the disclosure of which is hereby incorporated by reference herein in its entirety.

### BACKGROUND

### Field of Invention

The present disclosure relates to meta-lens. More particularly, the present disclosure relates to arrangement method of nano-pillars on the meta-lens.

### Description of Related Art

Compared to the traditional lens, the meta-lens with planar and thin characteristics can reduce volume and weight of the optical system. The design of the nano-pillar array of the meta-lens is based on the phase value of the nano-pillars relative to the surrounding environment. When the light passes through the meta-lens, the direction of the light path can be controlled due to the light delayed by the partial phase gradient of the nano-pillar array. However, the manufacturing process of the nano-pillar array may be limited by the manufacturing apparatus and the process parameter. If the design of the nano-pillar array is out of the processable specification, it may be difficult for the resulting nano-pillar array to provide expected optical function and decreases the yield of the meta-lens.

### SUMMARY

According to some embodiments of the present disclosure, an arrangement method of nano-pillars of a meta-lens includes the following steps. A first nano-pillar array is divided into a sub-unit matrix including multiple sub-units, where the sub-units include at least one out-of-specification sub-unit. An out-of-specification locating matrix is obtained from the sub-unit matrix to locate the out-of-specification sub-unit in the first nano-pillar array. An average phase matrix is obtained from the sub-unit matrix, and a substitution sub-unit database is built by using the out-of-specification locating matrix and the average phase matrix. The out-of-specification sub-unit in the first nano-pillar array is selectively substituted by using the substitution sub-unit database to obtain a second nano-pillar array.

According to some embodiments of the present disclosure, an arrangement method of nano-pillars of a meta-lens includes the following steps. A first nano-pillar array is divided into a sub-unit matrix including multiple sub-units, where the sub-units include multiple out-of-specification sub-units. A first matrix operation is performed on the sub-unit matrix to obtain an out-of-specification locating matrix. A second matrix operation is performed on the sub-unit matrix to obtain an average phase matrix. A matrix slicing is performed on the average phase matrix in accordance with the out-of-specification locating matrix to obtain an average phase value distribution diagram, where the average phase value distribution diagram includes multiple phase value intervals. Multiple within-specification substitution sub-units are designed by using the average phase value distribution diagram. A first out-of-specification sub-unit of the out-of-specification sub-units is substituted with a first substitution sub-unit of the within-specification substitution sub-units, where an average phase value of the first substitution sub-unit and an average phase value of the first out-of-specification sub-unit fall within one of the phase value intervals.

According to the above-mentioned embodiments of the present disclosure, the arrangement method of the nano-pillars of the meta-lens includes locating the out-of-specification sub-unit in the nano-pillar array by multiple matrix operations and designing the within-specification substitution sub-unit based on the phase value of the out-of-specification sub-unit. Therefore, the phase value and the processable specification of the nano-pillar array may both be realized after partially adjusting the nano-pillar arrangement by the within-specification substitution sub-unit, which improves the yield of the meta-lens.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a flowchart of the arrangement method of the nano-pillars of the meta-lens according to some embodiments of the present disclosure.

FIGS. 2A-2F illustrate schematic operation diagrams of arranging the nano-pillar array of the meta-lens by the method in FIG. 1.

FIG. 3A illustrates a top view of a nano-pillar array before substitution according to some embodiments of the present disclosure.

FIG. 3B illustrates a top view of the nano-pillar array in FIG. 3A after substitution.

### DETAILED DESCRIPTION

The following disclosure provides many different embodiments, or examples, for implementing different features of the provided subject matter. Specific examples of values, arrangements, etc., are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments of the present disclosure provide arrangement methods of the nano-pillars of the meta-lens, where the method includes dividing an original nano-pillar array into a sub-unit matrix, locating an out-of-specification sub-unit by matrix operations, obtaining an average phase value of the out-of-specification sub-unit by matrix operations, building a substitution sub-unit database by using the average phase value, and selectively substituting the out-of-specification sub-unit by matrix operation and the substitution sub-unit database. The resulting nano-pillar array after substitution may have the predetermined phase value and the nano-pillar gaps within the processable specification, thereby improving the manufacturing yield of the meta-lens.

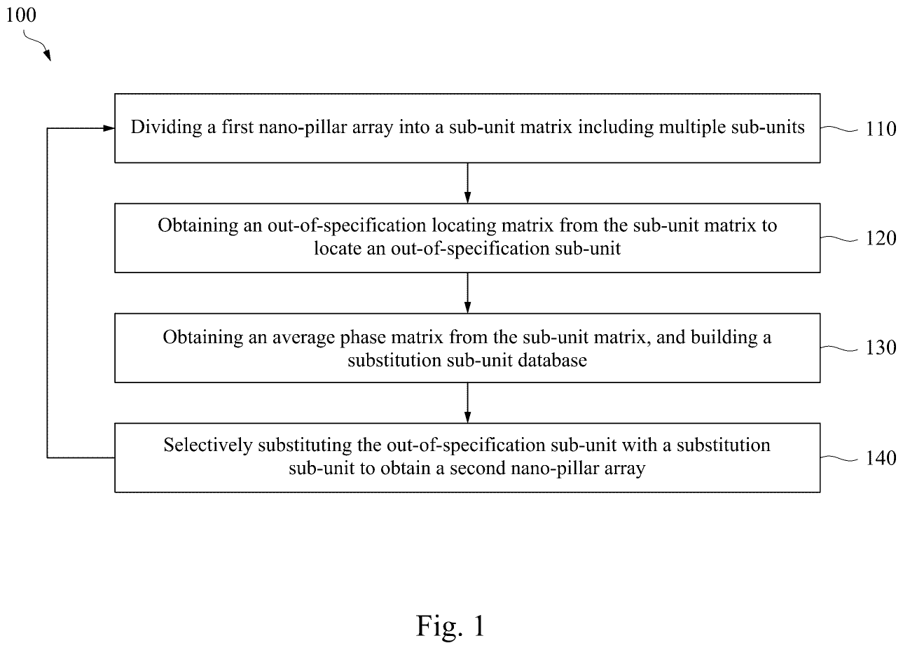

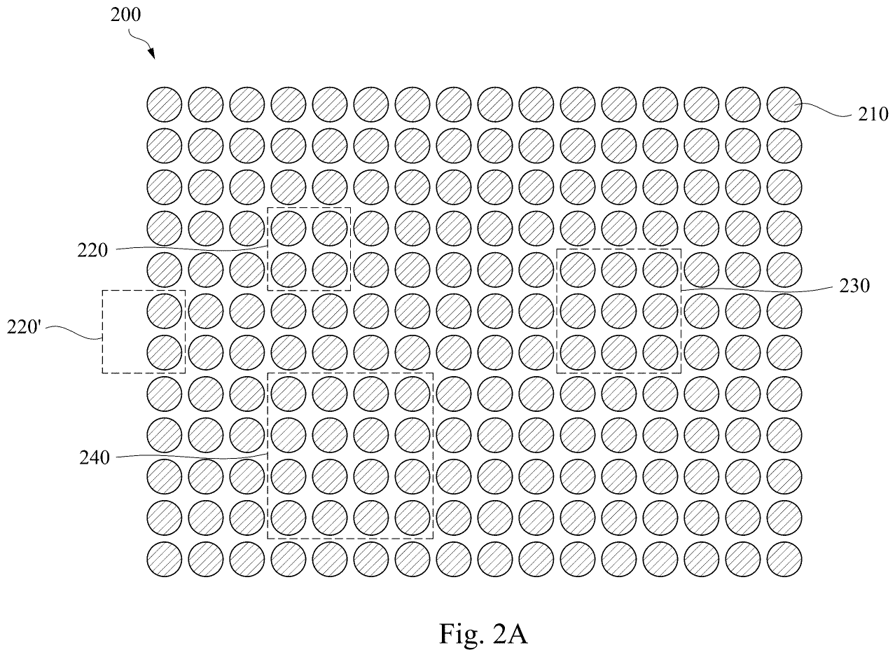

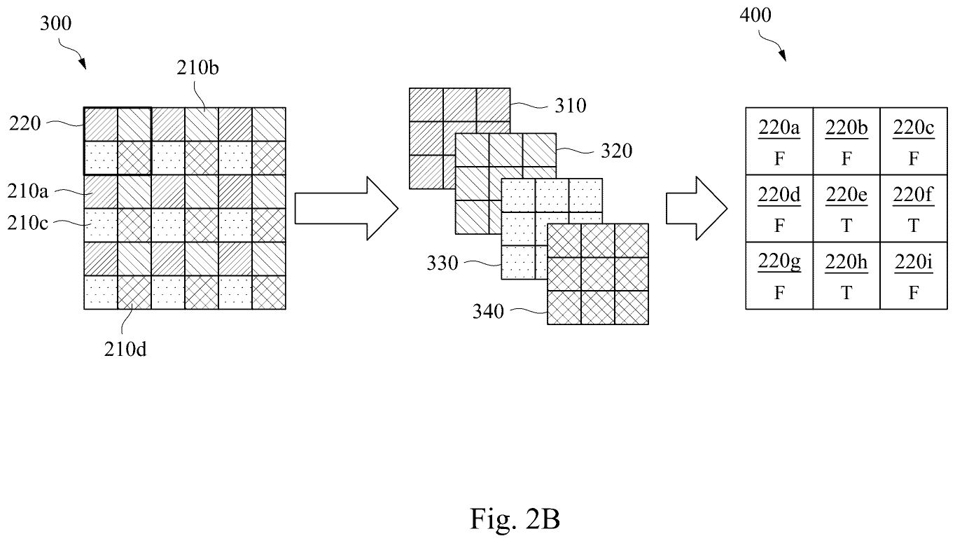

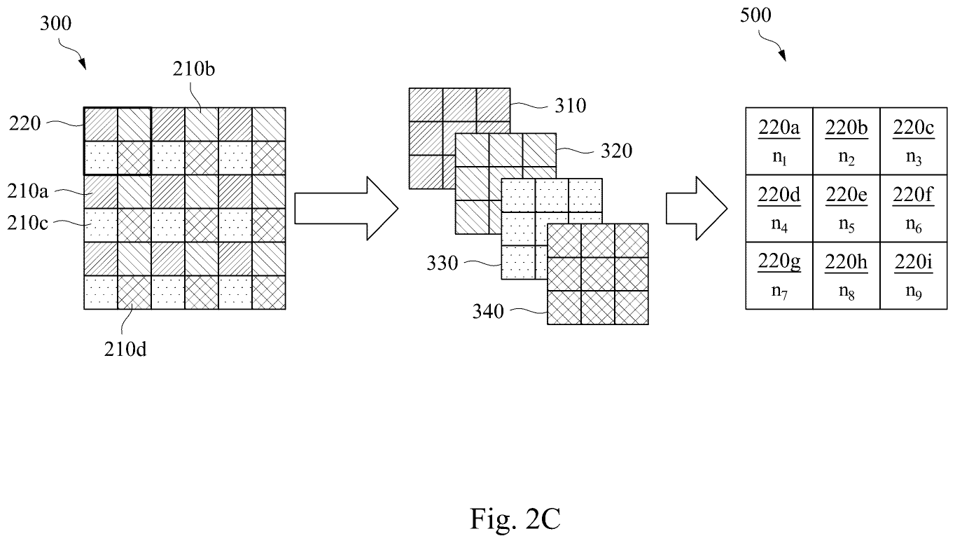

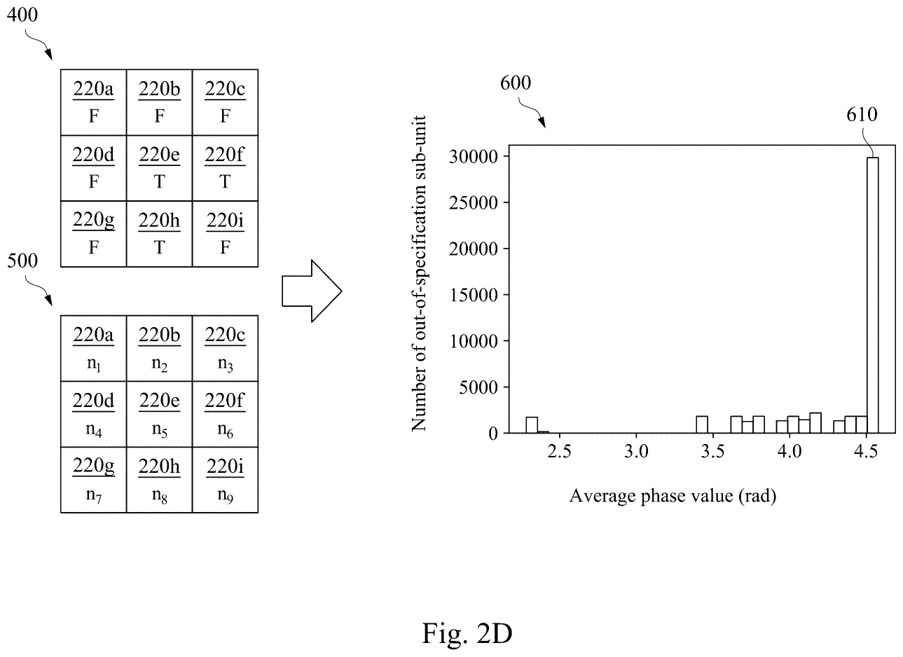

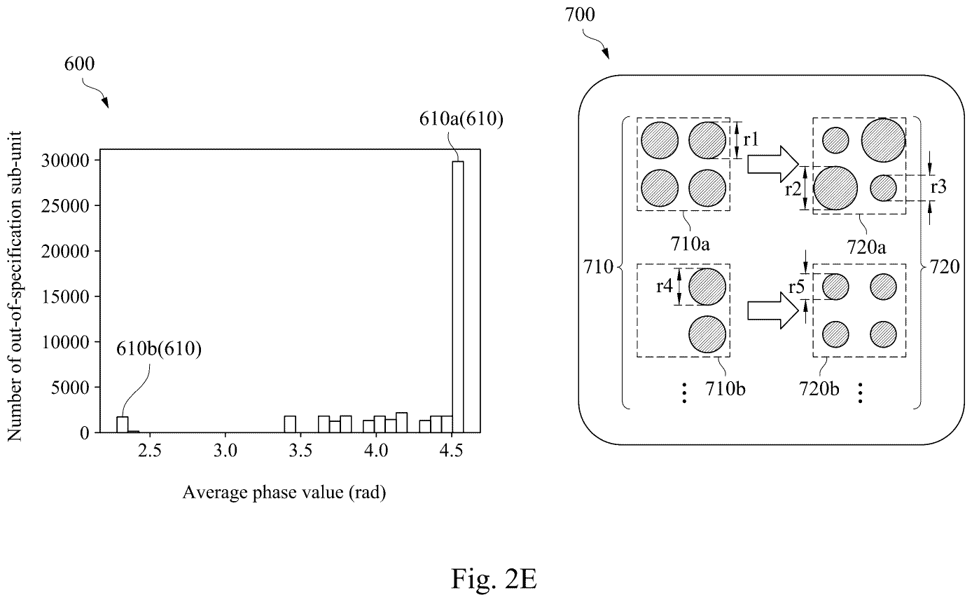

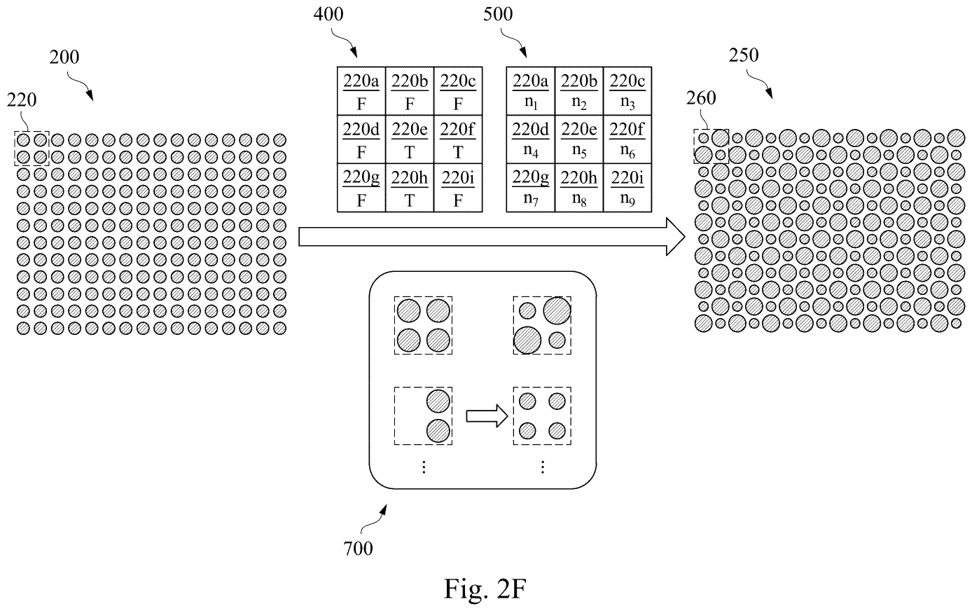

According to some embodiments of the present disclosure, FIG. 1 illustrates a flowchart of the arrangement method 100 of the nano-pillars of the meta-lens, and FIGS. 2A-2F illustrate the schematic operation diagrams of arranging the nano-pillar array of the meta-lens by the method 100 in FIG. 1. The details of the method 100 would be further discussed by referring to both FIG. 1 and FIGS. 2A-2F. The method 100 illustrated in FIG. 1 is taken as an example. Additional steps may be added before, during, or after the method 100, or some steps in the method 100 may be replaced, eliminated, or moved in some other embodiments.

Referring to FIG. 1 and FIG. 2A, in the step 110, a first nano-pillar array for the meta-lens divided into a sub-unit matrix including multiple sub-units. Specifically, the first nano-pillar array 200 is first provided as the original nano-pillar arranging design of the meta-lens before performing the method 100, for example, the top view of the first nano-pillar array 200 illustrated in FIG. 2A. The first nano-pillar array 200 includes multiple nano-pillars 210 arranged in a two-dimensional array to provide the predetermined phase value and optical performance of the meta-lens. For the sake of simplicity, the first nano-pillar array 200 in FIG. 2A includes the nano-pillars 210 with the same dimension and the same gap between, but the first nano-pillar array having various nano-pillar dimensions or other pattern of nano-pillars is also contemplated in the scope of the present disclosure.

In the step 110, the nano-pillars 210 of the first nano-pillar array 200 are divided into multiple sub-units by dummy lines. Each sub-unit includes multiple nano-pillars 210, and the nano-pillars 210 in the sub-unit are intact. In other words, the dummy lines as the sub-unit boundaries in the top view are positioned between two locations for the nano-pillars 210, respectively. The sub-units are continuously and adjacently arranged, so that the sub-units form a sub-unit matrix representing the first nano-pillar array 200. In the following steps of the method 100, performing the operations on the sub-unit matrix may expedite the arranging process of the nano-pillars.

The dimension of the sub-unit is based on the nano-pillar pattern of the sub-unit, and the dimension of the sub-unit may be adjusted in accordance with the number or arrangement of the nano-pillars in the first nano-pillar array 200. Taking FIG. 2A as an example, four nano-pillars 210 in the adjacent two columns and in the adjacent two rows may be grouped into a sub-unit 220, which divides the first nano-pillar array 200 into multiple sub-units 220 with the dimension of 2×2 array. Similarly, the first nano-pillar array 200 may be divided into the sub-units 230 with the dimension of 3×3 array or the sub-units 240 with the dimension of 4×4 array.

In some embodiments, one of the sub-unit 220 to the sub-unit 240 may be selected as the sub-unit dividing standard for the first nano-pillar array 200, so that the first nano-pillar array 200 is divided into the sub-units having the same dimension to expedite the arranging process of the nano-pillars. It should be noted that when a nano-pillar 210 is removed in some sub-units or some sub-units are positioned on the boundary line of the first nano-pillar array 200, the vacancy at the location for the nano-pillar 210 would be remained in these sub-units to keep the dimension of these sub-units same as that of other sub-units. For example, the sub-unit 220 and the sub-unit 220′ both have the dimension of 2×2 array, where the sub-unit 220 includes four nano-pillars 210, and the sub-unit 220′ includes two nano-pillars 210 and two vacancies for the nano-pillar.

Referring to FIG. 2B, the sub-unit matrix 300 represents a portion of the first nano-pillar array after the division, where the sub-unit matrix 300 includes thirty six locations for the nano-pillars arranged as a 6×6 array. The sub-unit matrix 300 is formed by nine sub-units 220 having the dimension of 2×2 array. Each sub-unit 220 has a block 210a at the upper-left corner, a block 210b at the upper-right corner, a block 210c at the lower-left corner, and a block 210d at the lower-right corner, where each of the block 210a to the block 210d represents a location for an existed nano-pillar or a nano-pillar vacancy. For the sake of simplicity, the sub-unit matrix 300 with the sub-units 220 would be taken as the example for the following steps, but the sub-unit matrix having other sub-unit dimension (such as the sub-unit 230 or the sub-unit 240 in FIG. 2A), other number of nano-pillars, or other pattern of nano-pillars is also contemplated in the scope of the present disclosure.

Referring to FIG. 1 and FIG. 2B, in the step 120, an out-of-specification locating matrix is obtained from the sub-unit matrix to locate an out-of-specification sub-unit in the sub-unit matrix. In the embodiments of the present disclosure, when the nano-pillar arrangement of a sub-unit does not meet the processable specification for stable manufacturing, this sub-unit is referred to as an “out-of-specification sub-unit”. For example, if a predetermined gap between neighboring nano-pillars in a sub-unit is smaller than the smallest gap that can be realized by the processing technique, the possibility of the neighboring nano-pillars contacting each other can be increased, and the phase value of the resulting sub-unit can be changed. In other words, this predetermined gap for the nano-pillars does not meet the processable specification, leading to the adhesion between the nano-pillars and the decreased yield of the meta-lens. For locating the out-of-specification sub-unit and modifying its nano-pillar arrangement, the out-of-specification locating matrix may be obtained from the sub-unit matrix by using the process conditions for the nano-pillar arrangement. Therefore, the location of the out-of-specification sub-unit may be selected without selecting the within-specification sub-unit that does not require substitution.

Specifically, a matrix slicing is first performed on the sub-unit matrix 300 to obtain multiple sub-matrices. The matrix slicing on the sub-unit matrix 300 is performed in accordance with the locations for the nano-pillars in one sub-unit 220, so that the number of the sub-matrices is equal to the number of the blocks, such as the block 210a to the block 210d, in one sub-unit 220. Each of the sub-matrices is formed by the blocks at the same location in the sub-units 220, where the dimension of a sub-matrix is in accordance with the number of the sub-units 220 in the sub-unit matrix 300. After the matrix slicing on the sub-unit matrix 300, a sub-matrix 310 formed by the blocks 210a, a sub-matrix 320 formed by the blocks 210b, a sub-matrix 330 formed by the blocks 210c, and a sub-matrix 340 formed by the blocks 210d may be obtained, where each of the sub-matrix 310 to the sub-matrix 340 has the dimension of 3×3 array.

Then, a matrix operation is performed on the sub-matrix 310 to the sub-matrix 340 to define the relationship between the gap between the neighboring nano-pillars in the sub-unit 220 and the smallest processable gap. The sub-unit 220 includes four pairs of neighboring locations for the nano-pillars, i.e., the block 210a and the block 210b, the block 210c and the block 210d, the block 210a and the block 210c, and the block 210b and the block 210d. If the gap between at least one pair of neighboring nano-pillars in one sub-unit 220 is smaller than the smallest processable gap, this sub-unit is considered as an out-of-specification sub-unit. If the gaps between any pair of neighboring nano-pillars in one sub-unit 220 are all larger than or equal to the smallest processable gap, this sub-unit is considered as a within-specification sub-unit.

The matrix operation performed in FIG. 2B is presented as Formula (I) to Formula (IV) below:

$$\frac{( u 1 - a ) + ( u 1 - b )}{2} < S \qquad Formula ( 1 )$$

$$\frac{( u 2 - c ) + ( u 2 - d )}{2} < S \qquad Formula ( 2 )$$

$$\frac{( u 3 - a ) + ( u 3 - c )}{2} < S \qquad Formula ( 3 )$$

$$\frac{( u 4 - b ) + ( u 4 - d )}{2} < S . \qquad Formula ( 4 )$$

In Formula (I) to Formula (IV), (a, b, c, d) represents (the nano-pillar diameter in the block 210a, the nano-pillar diameter in the block 210b, the nano-pillar diameter in the block 210c, the nano-pillar diameter in the block 210d), (u1, u2, u3, u4) represents (the distance between the nano-pillar center in the block 210a and the nano-pillar center in the block 210b, the distance between the nano-pillar center in the block 210c and the nano-pillar center in the block 210d, the distance between the nano-pillar center in the block 210a and the nano-pillar center in the block 210c, the distance between the nano-pillar center in the block 210b and the nano-pillar center in the block 210d), and S represents the smallest processable gap. When a gap between the neighboring nano-pillars is smaller than the smallest processable gap, a true value (T) would be obtained from Formula (I) to Formula (IV). When a gap between the neighboring nano-pillars is larger than or equal to the smallest processable gap, a false value (F) would be obtained from Formula (I) to Formula (IV). In some embodiments, the nano-pillars in the sub-unit matrix 300 may be arranged with the same pitch, so that u1 in Formula (I), u2 in Formula (II), u3 in Formula (III), and u4 in Formula (IV) are the same value. In other words, u1 to u4 in Formula (I) to Formula (IV) may be substituted with a same parameter u.

A Boolean matrix may be obtained from each of the matrix operation Formula (I) to Formula (IV), where each matrix element in the Boolean matrix represents whether a gap between a pair of neighboring nano-pillars is smaller than the smallest processable gap. The number of the Boolean matrices is equal to the number of neighboring nano-pillars in pairs in one sub-unit 220, and the dimension of a Boolean matrix is the same as the dimension of a sub-matrix. As a result, four Boolean matrices having the dimension of 3×3 array are obtained after performing Formula (I) to Formula (IV) on the sub-matrix 310 to the sub-matrix 340. Then, an OR matrix operation is performed on the four Boolean matrices to obtain the out-of-specification locating matrix 400. In the out-of-specification locating matrix 400, the true value (T) represents the gap between at least one pair of neighboring nano-pillars is smaller than the smallest processable gap, while the false value (F) represents the gaps between any pair of neighboring nano-pillars are larger than or equal to the smallest processable gap. Therefore, the out-of-specification locating matrix 400 in FIG. 2B includes the out-of-specification sub-unit 220e, sub-unit 220f, and sub-unit 220h with the nano-pillar arrangements needed to be modified and includes the within-specification sub-unit 220a, sub-unit 220b, sub-unit 220c, sub-unit 220d, sub-unit 220g, and sub-unit 220i with the original arrangement that can be remained.

Referring to FIG. 1 and FIGS. 2C-2E, in the step 130, an average phase matrix is obtained from the sub-unit matrix, and a substitution sub-unit database is built. As mentioned above, the first nano-pillar array is the original nano-pillar design for the meta-lens. To maintain the predetermined optical function of the meta-lens, not only the gaps between the neighboring nano-pillars but also the phase values of the nano-pillars should be taken into account when modifying the nano-pillar arrangement of the out-of-specification sub-unit. Therefore, the average phase value of the out-of-specification sub-unit can be set as a modifying target. The substitution sub-unit database can then be built with the similar average phase value and the nano-pillar gap within the processable specification for modifying the out-of-specification sub-unit.

As shown in FIG. 2C, a matrix slicing is first performed on the sub-unit matrix 300 to obtain the sub-matrix 310, the sub-matrix 320, the sub-matrix 330, and the sub-matrix 340. The matrix slicing operation on the sub-unit matrix 300 in FIG. 2C is basically same as the matrix slicing operation on the sub-unit matrix 300 in FIG. 2B, so that the details of the matrix slicing operation in FIG. 2C may referring to the description related to FIG. 2B. A matrix operation is then performed on the sub-matrix 310 to the sub-matrix 340 to obtain the average phase value of each sub-unit 220. The matrix operation performed in FIG. 2C is presented as Formula (V) below:

$$\frac{A}{n} = p …$$

Formula (V), where A represents a sum of the nano-pillar phase values of all blocks (i.e., the block 210a, the block 210b, the block 210c, and the block 210d) in one sub-unit 220, n represents the number of all blocks in the one sub-unit 220, and p represents the average phase value of the one sub-unit 220. An average phase matrix 500 having the dimension of 3×3 array may be obtained after performing the matrix operation on the sub-matrix 310 to the sub-matrix 340, where the dimension of the average phase matrix 500 is the same as the dimension of the out-of-specification locating matrix 400. Each matrix element in the average phase matrix 500 is the average phase value n1 to the average phase value n9 of the sub-unit 220a to the sub-unit 220i, respectively.

As shown in FIG. 2D, a matrix slicing is then performed on the average phase matrix 500 in accordance with the out-of-specification locating matrix 400 to obtain the average phase values (i.e., the average phase value n5, the average phase value n6, and the average phase value n8) of the out-of-specification sub-units (i.e., the sub-unit 220e, the sub-unit 220f, and the sub-unit 220h) in the out-of-specification locating matrix 400. The average phase value and the number of the corresponding out-of-specification sub-units are illustrated into a statistic diagram, resulting in the average phase value distribution diagram. The average phase value distribution diagram 600 in FIG. 2D is taken as an example, where the average phase value distribution diagram 600 includes all out-of-specification sub-units in the first nano-pillar array. As seen from the average phase value distribution diagram 600, the average phase values of the out-of-specification sub-units in the first nano-pillar array is in a range of about 2.3 radians (rad) to about 4.6 radian.

Additionally, the average phase values in the average phase value distribution diagram 600 may be divided into multiple phase value intervals 610, where the range of the average phase values of one phase value interval 610 depends on the technique precision for measuring phase value. In some embodiments, the average phase values of the phase value interval 610 may lie within about one standard deviation of the mean of the average phase values. Taking the average phase value distribution diagram 600 as an example, the rightmost phase value interval 610 in the diagram has the most out-of-specification sub-units. The mean of the average phase values of this rightmost phase value interval 610 is about 4.55 radians, and the average phase values of this rightmost phase value interval 610 is in a range of about 4.5 radians to about 4.6 radians.

As shown in FIG. 2E, the average phase value distribution diagram 600 is then used to design an original sub-unit 710 and a substitution sub-unit 720 in a substitution sub-unit database 700. As mentioned above, the nano-pillar arrangement of the out-of-specification sub-unit needs to be modified to meet the specification of the processable gap. If the nano-pillars in the out-of-specification sub-unit are simply substituted with smaller nano-pillars to meet the processable specification, the phase value of the substituted sub-unit may be much different from the phase value of the out-of-specification sub-unit, and the direction of the light path through the meta-lens is correspondingly changed. Therefore, in the substitution sub-unit database 700, the gaps between neighboring nano-pillars in the substitution sub-unit 720 are within the processable specification, and the average phase value of the substitution sub-unit 720 is close to the average phase value of the original sub-unit 710.

Specifically, one of the phase value intervals 610 in the average phase value distribution diagram 600 is selected, and the out-of-specification sub-unit in this phase value interval 610 is selected as an original sub-unit 710 in the substitution sub-unit database 700. The nano-pillar parameters, such as dimension, numbers, or the like, of the original sub-unit 710 are then modified to generate the nano-pillar arrangement for a substitution sub-unit 720 in the substitution sub-unit database 700, where the average phase value of the substitution sub-unit 720 and the average phase value of the original sub-unit 710 fall within the same phase value interval 610. The gaps between any pair of neighboring nano-pillars in the substitution sub-unit 720 are larger than or equal to the smallest processable gap; namely, the substitution sub-unit 720 may be referred to as a within-specification substitution sub-unit. In some embodiments, the substitution between a pair of the original sub-unit 710 and the substitution sub-unit 720 may be defined for each of the phase value intervals 610, so that the number of the substitution sub-units 720 in the substitution sub-unit database 700 is equal to the number of the phase value intervals 610.

For example, the most out-of-specification sub-units in the phase value interval 610a may be selected as the original sub-unit 710a, where the original sub-unit 710a includes four nano-pillars. The diameter r1 of the four nano-pillars in the original sub-unit 710a is so large that the gaps between any pair of neighboring nano-pillars in the original sub-unit 710a are smaller than the smallest processable gap. The average phase value of the substitution sub-unit 720a also falls within the phase value interval 610a, but the substitution sub-unit 720a includes two nano-pillars having the diameter r2 and two nano-pillars having the diameter r3. The diameter r1 is smaller than the diameter r2 but larger than the diameter r3, while the nano-pillars having the diameter r2 and the nano-pillars having the diameter r3 are alternately arranged in the substitution sub-unit 720a. The mixed-pillar arrangement of the larger nano-pillar and the smaller nano-pillar in the substitution sub-unit 720a may modify the gap between neighboring nano-pillars to meet the processable specification, and it may also provide the average phase value of the substitution sub-unit 720a close to that of the original sub-unit 710a.

For another example, the most out-of-specification sub-units in the phase value interval 610b may be selected as the original sub-unit 710b, where the original sub-unit 710b includes two neighboring nano-pillars and two nano-pillar vacancies adjacent to the nano-pillars. The diameter r4 of the two neighboring nano-pillars in the original sub-unit 710b is so large that the gap between the two nano-pillars in the original sub-unit 710b is smaller than the smallest processable gap. The average phase value of the substitution sub-unit 720b falls within the phase value interval 610b, while the substitution sub-unit 720b includes four nano-pillars having the diameter r5 smaller than the diameter r4. The larger number of the smaller nano-pillars in the substitution sub-unit 720b may modify the gap between neighboring nano-pillars to meet the processable specification, and it may also provide the average phase value of the substitution sub-unit 720b close to that of the original sub-unit 710b. In some embodiments, the average phase value of the substitution sub-unit 720a may be equal to the average phase value of the original sub-unit 710a, the average phase value of the substitution sub-unit 720b may be equal to the average phase value of the original sub-unit 710b, and the average phase value of the substitution sub-unit 720a is different from the average phase value of the substitution sub-unit 720b.

Referring to FIG. 1 and FIG. 2F, in the step 140, the out-of-specification sub-unit in the first nano-pillar array is selectively substituted with the within-specification substitution sub-unit in the substitution sub-unit database to obtain a second nano-pillar array after the substitution. Specifically, in ascending order of the phase value intervals in the average phase value distribution diagram (for example, the average phase value distribution diagram 600 in FIG. 2E), a phase value interval is selected as the target phase value interval. A matrix slicing is then performed on the first nano-pillar array 200 in accordance with the out-of-specification locating matrix 400 and the average phase matrix 500 to locate the out-of-specification sub-units 220 having the average phase value within the target phase value interval. The average phase value of the located out-of-specification sub-unit 220 is compared with the average phase values of the within-specification substitution sub-units in the substitution sub-unit database 700 to find out the substitution sub-unit 260 having the average phase value closest to that of the out-of-specification sub-unit 220. The out-of-specification sub-unit 220 in the first nano-pillar array 200 is then substituted with the substitution sub-unit 260. Another phase value interval is selected as the next target phase value interval, and the above-mentioned locating step and substituting step for the out-of-specification sub-unit are repeated until all out-of-specification sub-units in the first nano-pillar array 200 are substituted with the within-specification substitution sub-units. As a result, a second nano-pillar array 250 within the processable specification and having the predetermined phase value of the meta-lens is obtained.

In some embodiments, after the first nano-pillar array 200 is modified into the second nano-pillar array 250, the method 100 may be performed again on the second nano-pillar array 250 to check if the second nano-pillar array 250 has none out-of-specification sub-units or little out-of-specification sub-units that does not significantly affect the yield. Specifically, the step 110 is performed on the second nano-pillar array 250 to divide the second nano-pillar array 250 into a new sub-unit matrix, where the locations of the sub-units in the second nano-pillar array 250 do not fully overlap the locations of the sub-units in the first nano-pillar array 200. The subsequent steps in the method 100 are then performed on the second nano-pillar array 250 to locate the out-of-specification sub-units not shown in the first nano-pillar array 200 by multiple matrix operations, so that the second nano-pillar array 250 may be substituted with a third nano-pillar array (not shown).

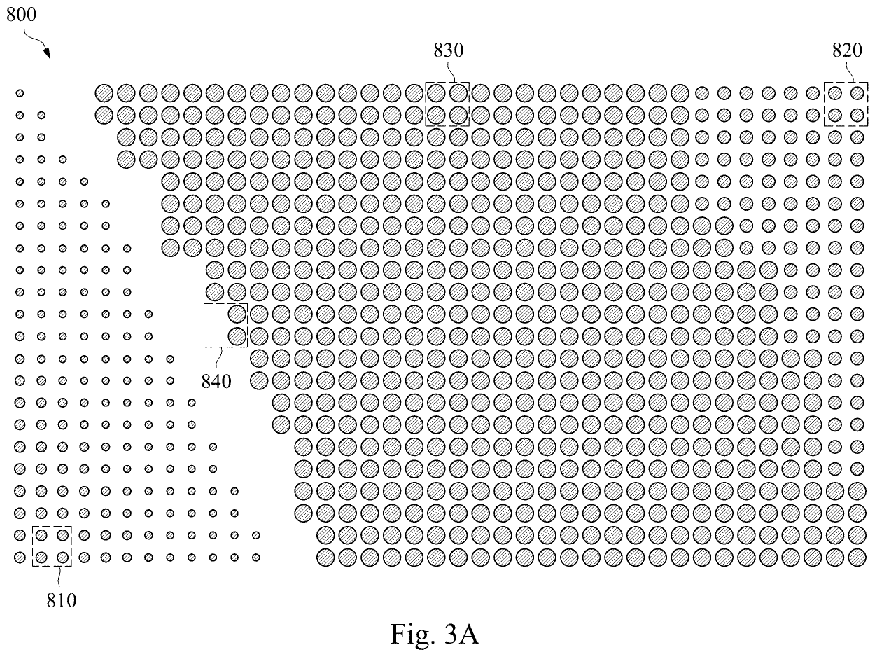

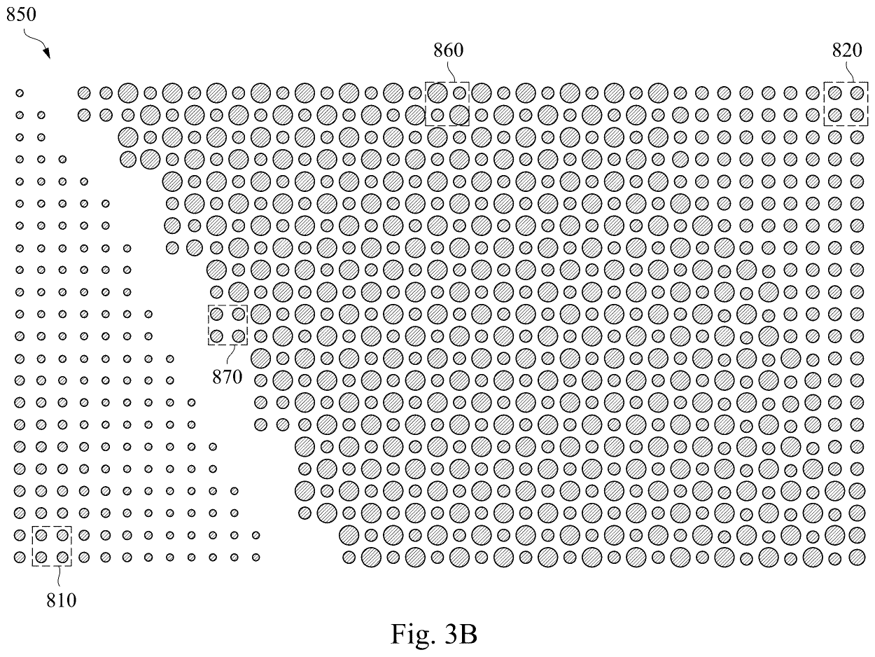

Referring to FIG. 3A and FIG. 3B, the first nano-pillar array 800 is a nano-pillar array before substituting the out-of-specification sub-units, and the second nano-pillar array 850 is the nano-pillar array modified from the first nano-pillar array 800 by using the method 100 in FIG. 1. The sub-unit 810 and the sub-unit 820 are the within-specification sub-units in the first nano-pillar array 800, thereby being remained in the second nano-pillar array 850. The sub-unit 830 is an out-of-specification sub-unit with the gap too small between neighboring nano-pillars, thereby being substituted with the substitution sub-unit 860 in the second nano-pillar array 850. Similarly, the sub-unit 840 is also an out-of-specification sub-unit, thereby being substituted with the substitution sub-unit 870 in the second nano-pillar array 850.

Since the first nano-pillar array 800 is modified based on the nano-pillar gap and the nano-pillar phase value, and the partial nano-pillar arrangement in the first nano-pillar array 800 is selectively modified by the matrix operations, the phase value distribution in the first nano-pillar array 800 is similar or the same as the phase value distribution in the second nano-pillar array 850. Accordingly, when the meta-lens is manufactured in accordance with the second nano-pillar array 850, the original optical function of the first nano-pillar array 800 may be remained, while the risk of the adhesion between the nano-pillars and the non-functioning meta-lens is reduced.

According to the above-mentioned embodiments of the present disclosure, the arrangement method of the nano-pillars of the meta-lens includes dividing the original nano-pillar array into the sub-unit matrix, fast locating the out-of-specification sub-units that have the nano-pillar arrangement to be modified by the matrix operation, and obtaining the average phase values of the out-of-specification sub-units by the matrix operation. The substitution sub-unit database may be built by using the average phase values of the out-of-specification sub-units, so the substitution sub-units have both the predetermined phase value of the original nano-pillar array and the nano-pillar gaps within the processable specification. The application of the matrix operations and the substitution sub-unit database may fast modify the partial nano-pillar arrangement, which remains the predetermined optical function of the meta-lens and improves the yield of the meta-lens.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An arrangement method of nano-pillars of a meta-lens, comprising:
dividing a first nano-pillar array into a sub-unit matrix comprising multiple sub-units, wherein the sub-units comprise at least one out-of-specification sub-unit;
obtaining an out-of-specification locating matrix from the sub-unit matrix to locate the at least one out-of-specification sub-unit in the first nano-pillar array;
obtaining an average phase matrix from the sub-unit matrix, and building a substitution sub-unit database by using the out-of-specification locating matrix and the average phase matrix; and
selectively substituting the at least one out-of-specification sub-unit in the first nano-pillar array by using the substitution sub-unit database to obtain a second nano-pillar array.

2. The method of claim 1, wherein the substitution sub-unit database comprises a within-specification substitution sub-unit, and an average phase value of the within-specification substitution sub-unit is equal to an average phase value of the at least one out-of-specification sub-unit.

3. The method of claim 2, wherein the within-specification substitution sub-unit comprises alternately arranged first nano-pillars and second nano-pillars, and a diameter of the first nano-pillars is larger than a diameter of the second nano-pillars.

4. The method of claim 1, wherein the at least one out-of-specification sub-unit comprises neighboring nano-pillars and a nano-pillar vacancy adjacent to the nano-pillars.

5. The method of claim 1, further comprising:
dividing the second nano-pillar array into an additional sub-unit matrix comprising multiple additional sub-units, wherein locations of the additional sub-units in the second nano-pillar array do not fully overlap locations of the sub-units in the first nano-pillar array; and
locating and substituting an additional out-of-specification sub-unit of the additional sub-units by using the additional sub-unit matrix.

6. The method of claim 1, wherein dividing the first nano-pillar array into the sub-unit matrix comprises:
dividing nano-pillars of the first nano-pillar array into the sub-units by dummy lines, wherein the dummy lines are positioned between two locations for the nano-pillars, respectively.

7. An arrangement method of nano-pillars of a meta-lens, comprising:
dividing a first nano-pillar array into a sub-unit matrix comprising multiple sub-units, wherein the sub-units comprise multiple out-of-specification sub-units;
performing a first matrix operation on the sub-unit matrix to obtain an out-of-specification locating matrix;
performing a second matrix operation on the sub-unit matrix to obtain an average phase matrix;
performing a matrix slicing on the average phase matrix in accordance with the out-of-specification locating matrix to obtain an average phase value distribution diagram, wherein the average phase value distribution diagram comprises multiple phase value intervals;
designing multiple within-specification substitution sub-units by using the average phase value distribution diagram; and
substituting a first out-of-specification sub-unit of the out-of-specification sub-units with a first substitution sub-unit of the within-specification substitution sub-units, wherein an average phase value of the first substitution sub-unit and an average phase value of the first out-of-specification sub-unit fall within one of the phase value intervals.

8. The method of claim 7, wherein the first matrix operation comprises:
performing a matrix slicing on the sub-unit matrix to obtain multiple sub-matrices;
performing a matrix operation formula:
$$\frac{( u - a ) + ( u - b )}{2} < S$$
on the sub-matrices to obtain multiple Boolean matrices,
wherein, in the matrix operation formula, u is a distance between centers of a pair of neighboring nano-pillars in the sub-units, a and b are respective nano-pillar diameters of the pair of neighboring nano-pillars, and S is a smallest processable gap; and
performing an OR operation on the Boolean matrices to obtain the out-of-specification locating matrix.

9. The method of claim 8, wherein a true value in the Boolean matrices is obtained from the matrix operation formula when a gap between the pair of neighboring nano-pillars is smaller than the smallest processable gap, and
wherein a false value in the Boolean matrices is obtained from the matrix operation formula when a gap between the pair of neighboring nano-pillars is larger than or equal to the smallest processable gap.

10. The method of claim 8, wherein a number of the sub-matrices is equal to a number of locations for nano-pillars in one of the sub-units.

11. The method of claim 8, wherein a dimension of one of the sub-matrices is in accordance with a number of the sub-units in the sub-unit matrix.

12. The method of claim 8, wherein a number of the Boolean matrices is equal to a number of neighboring nano-pillars in pairs in one of the sub-units.

13. The method of claim 8, wherein a dimension of one of the Boolean matrices is same as a dimension of one of the sub-matrices.

14. The method of claim 7, wherein the second matrix operation comprises:
performing a matrix slicing on the sub-unit matrix to obtain multiple sub-matrices; and
performing a matrix operation formula:
$$\frac{A}{n} = p$$
on the sup-matrices to obtain the average phase matrix,
wherein, in the matrix operation formula, A is a sum of nano-pillar phase values of one of the sub-units, n is an number of locations for nano-pillars in the one of the sub-units, and p an average phase value of the one of the sub-units.

15. The method of claim 14, wherein the matrix slicing on the sub-unit matrix is performed in accordance with locations for nano-pillars in one of the sub-units.

16. The method of claim 7, wherein a dimension of the average phase matrix is same as a dimension of the out-of-specification locating matrix.

17. The method of claim 7, wherein average phase values of the one of the phase value intervals lie within one standard deviation of a mean of the average phase values of the one of the phase value intervals.

18. The method of claim 7, wherein a number of the within-specification substitution sub-units is equal to a number of the phase value intervals.

19. The method of claim 7, further comprising:
substitute a second out-of-specification sub-unit of the out-of-specification sub-units with a second substitution sub-unit of the within-specification substitution sub-units, wherein an average phase value of the second substitution sub-unit and an average phase value of the second out-of-specification sub-unit fall within another one of the phase value intervals.

20. The method of claim 19, wherein the average phase value of the second out-of-specification sub-unit is larger than the average phase value of the first out-of-specification sub-unit.
